(19) United States
(12) Patent Application Publication
(10) Pub. No.: US 2006/0019198 A1
(43) Pub. Date: Jan. 26, 2006

(54) Optical recording materials

(76) Inventors: Sue-Min Yeh, Banchiau City (TW); Kao-Ming Chang, Tainan (TW); Wen-Pin Chiu, Shindian City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/899,321

(22) Filed: Jul. 26, 2004

(51) Int. Cl. G11B 7/24

(52) U.S. Cl. 430/270.18; 430/945; 428/64.8

(57) ABSTRACT

An optical recording medium is provided on a substrate with a recording layer. The recording layer comprises at least one kind of organic compound, wherein the recording layer selectively has a larger sensitivity at the wavelength of laser beam ranging between 300 nm and 550 nm.

### BACKGROUND OF THE INVENTION

1. Field of the Invention

This invention relates to an optical recording medium, particularly to an optical recording medium, which is recorded and replayed by using a laser beam having the wavelength ranging from 300 nm to 550 nm.

2. Description of the Related Art

CD-R is a kind of optical recording medium, which is recorded by the wavelength 780 nm of laser beam. In the structure of an optical recording medium, an optical recording layer, a light reflective layer and a protective layer are laminated on a transparent substrate. When the laser beam is focused on the dye layer, energy is absorbed by part of organic dye, the area is become to deform, and then the data is recorded. While the recorded area is read by the same the wavelength of laser beam, data is read by analyzing the difference of reflectance between the deformed and un-deformed part of the dye layer.

A recordable digital video medium, such as DVD−R or DVD+R, is the other kind of optical recording discs, which is recorded by the laser beam with the wavelength between 630 nm to 680 nm. An optical recording layer, a light reflective layer and a protective layer are laminated on a transparent substrate with the thickness of 0.6 mm, and then another substrate with the same thickness is bonded to form an optical recording medium. The recording density of DVD−R/DVD+R is higher than that of CD-R by the reason of using shorter recording wavelength of laser beam and forming shallower pre-groove on the substrate.

Recently, recording to the development of Internet and high vision TV, higher recording density and quality medium is required. For the reason, the wavelength of laser beam used to record should be shorter. Developing a blue semiconductor laser ranging from 400 nm to 500 nm has been proceeding rapidly (For example, referring to Nikkei Electronics 1998, No 708, 117, Nikkei Electronics 1999, No 736, 33, Nikkei Electronics 1999, No 741, 28, Nikkei Electronics 1999, No 748, 19, Nikkei Electronics 1999 No 751, 117), and an optical recording medium corresponding to is also under development. Therefore, the recording density may be attending to 15 GB to 30 GB.

In forming a pit by irradiating a recording material with laser beam on an optical recording medium, chemical compounds with good optical constant, decomposition behavior and high sensitivity corresponding to the laser beam are required. When the material is not decomposed easily, or sensitivity is too low, it is difficult to form a reliable pit. When the data is recorded on a conventional CD-R by using blue laser, due to lower refractive index and unsuitable extinction coefficient of the recording layer, high recording properties cannot be obtained. For the reason, a compound with appreciate properties corresponding to blue semiconductor laser should be chosen.

Examples of organic or orgaometallic compounds for recording with blue laser beam, Japanese Patent Applications Laid Open (JP-A) No. JP-A2000-158818, JP-A2001-287460, JP-A2002-36727, JP-A2002-086923, JP-A2002-086925, JP-A2002-096558, JP-A2002-166655, JP-A2002-160452, JP-A2002-172865, JP-A2003-006931, JP-A2003-127542, JP-A2003-165272, JP-A2003-170622, JP-A2003-170622, JP-A2003-170663, JP-A2003-191642, JP-A2003-237233, JP-A2003-266939, JP-A2003-266954 and US Patent Application No. US2003-0091931, U.S. Pat. No. 6,699,556 disclose a recording and reproduction method wherein an optical recording medium having a recording layer containing compound such as a benzobisazole-based compound or a 1,2,3-triazole compound is irradiated with blue laser.

### SUMMARY OF THE INVENTION

The first object of this present invention is to provide an optical recording medium having excellent recording characteristics by irradiation with laser having wavelength in a range of 300 nm to 550 nm. The optical recording medium is provided on a substrate with a recording layer, the recording layer comprising at least one kind of organic compound, wherein the recording layer selectively has a larger sensitivity at the wavelength of laser beam in a range of 300 nm to 550 nm.

The second object of this invention is to provide an optical recording medium containing an optical recording material comprising the chemical compound represented by the general formula [I].

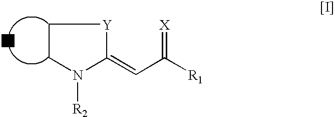

The optical recording medium is capable of high density recording by irradiating with laser beam having wavelength of 300 nm to 550 nm, particularly with laser beam having wavelength of 350 nm to 450 nm, and preferably with laser beam having wavelength of 390 nm to 410 nm.

### BRIEF DESCRIPTION OF THE DRAWINGS

FIG. 1 is the UV-VIS spectrum of dye solution in Synthesis Example 1 according to the invention; and

FIG. 2 is the UV-VIS spectrum of dye solution in Synthesis Example 2 according to the invention;

### DETAIL DESCRIPTION OF THE INVENTION

The first object of this present invention is to provide an optical recording medium having excellent recording characteristics by irradiation with laser having wavelength in a range of 300 nm to 550 nm; for example, with laser having wavelength of 350 nm to 450 nm, or 390 nm to 410 nm, selected optionally. The embodiments according to the present invention are described below in detail.

The optical recording medium of this invention mainly comprises an optical recording layer on a substrate. The recording layer comprises at least one kind of organic compound, and the recording layer has a larger sensitivity at the wavelength of laser beam ranging between 300 nm and 500 nm. The organic compound contained in the recording layer is represented by the general formula [I], 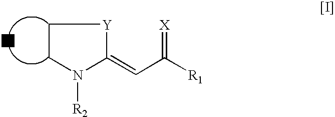
wherein

“R₁” is selected from substituted or unsubstitued alkyl, cyclic alkyl, phenyl, benzyl, alkylphenyl or phenoxyalkyl group.

“R₂” is selected from substituted or unsubstitued alkyl, cyclic alkyl, phenyl, benzyl, alkylphenyl or phenoxyalkyl group.

“A” is selected from phenyl or naphthyl substituted or unsubstitued alkyl, cyclic alkyl, phenyl, benzyl, alkylphenyl or phenoxyalkyl group.

“X” is an electron withdrawing atom or substituted group, such as an atom of oxygen or sulfur.

“Y” could be an atom, such as atom of oxygen (O), sulfur (S), or selenium (Se), or a group, such as group of CR₃R₄ or NR₅.

If Y is a group of CR₃R₄, “R₃” and “R₄” are the same or different from each other and selected from ubstituted or unsubstitued alkyl group, cyclic alkyl group or organometallic substitutent.

If Y is a group of NR₅, “R₅” is substituted or unsubstitued alkyl, cyclic alkyl, phenyl, benzyl, alkylphenyl and phenoxyalkyl group.

The dyes of the present invention have acceptable solubility in organic solvent. 2,2,3,3-tetrafluoro-propanol (TFP), 2,2,3,3,4,4,5,5-octafluoropentanol (OFP), methyl lactate, and ethyl lactate are suitable solvent to prepare dye coating solution for producing an optical recording media.

The compound of formula [I] can be synthesized according to the method suggested by Tetrahedron Letters 1979, 45, 4407, and is presented by the reaction scheme (1).

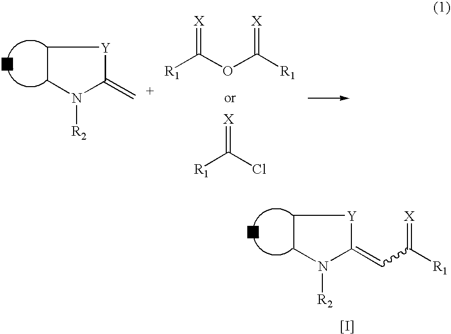

Examples of the compounds of formula [I], which are synthesized by the similar method in reaction scheme 1, are listed in Table 1. However, this invention shall not be limited by these examples.

TABLE 1

| Com- | | | | | | |
|---|---|---|---|---|---|---|
| pound | | | | | | λₘₐₓ (nm) |
| No. | A | R₁ | R₂ | X | Y | (solvent) |
| I-1 | 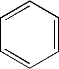 | Me | Propyl | O | C(CH₃₎₂ | 356 (TFP) |
| I-2 | 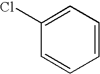 | Me | Propyl | O | C(CH₃₎₂ | 355 (TFP) |
| I-3 | 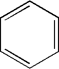 | Me | Benzyl | O | C(CH₃₎₂ | 355 (TFP) |
| I-4 | 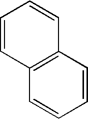 | Me | Butyl | O | C(CH₃₎₂ | 384 (TFP) |
| I-5 | 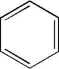 | 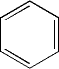 | Propyl | O | C(CH₃₎₂ | 369 (TFP) |
| I-6 | 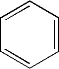 | Benzyl | Propyl | O | C(CH₃₎₂ | 370 (TFP) |

Synthesis examples of chemical compounds will be described below (Synthesize strategy is suggested according to Tetrahedron Letters 1979, 45, 4407). The absorption spectrum in a solution is measured by machine of “PE Spectrometer Lambda 20” (manufactured by Perkin Elmer), and Proton and Carbon NMR are measured by machine of “400 MHz” manufactured by Varian.

### SYNTHESIS EXAMPLE 1

Synthesis of Compound of Formula [I-1]

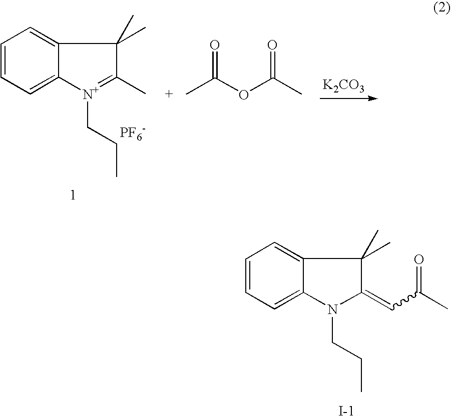

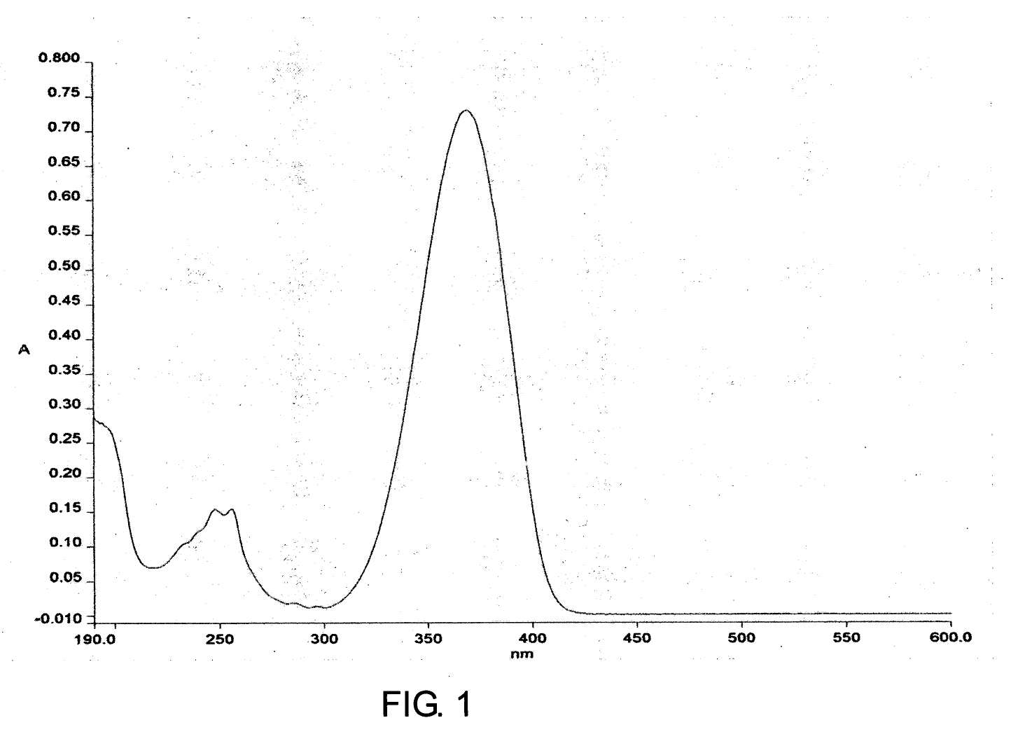

The synthesis process is as shown in the reaction scheme (2). First, 2,3,3-Trimethyl-1-propylindolinum hexafluorophosphate (formular [1]) (21.1 g, 61.9 mmol), K₂CO₃ (8.5 g, 59.4 mmol), Ac₂O (60 mL) are heated at a temperature of 100° C. for 3 hr. After cooling down to room temperature, the solution is poured into water (200 mL) and then precipitate is appeared. After filtrating, chemical compound of formula [I-1] is obtained (in a weight of 12.1 g, 80%). The spectrum result, as shown in FIG. 1, UV-VIS (TFP) is; □ₘₐₓ=369 nm (FIG. 1); ¹H NMR (400 MHz, CDCl₃) □ 0.99 (t, J=7.2 Hz, 3H), 1.63-1.81 (m, 8H), 2.18 (s, 3 H), 3.65 (t, J=7.2 Hz, 2 H), 5.32 (s, 1 H), 6.73 (d, J=7.6 Hz, 1 H), 6.94-6.99 (m, 1 H), 7.14-7.20 (m, 2 H); ¹³C NMR (100 MHz, CDCl₃) □ 11.6, 19.6, 23.7, 44.5, 48.2, 93.3, 107.7, 121.6, 121.8, 127.2, 139.8, 143.2, 169.8, 192.8.

### SYNTHESIS EXAMPLE 2

Synthesis of Compound of Formula [I-2]

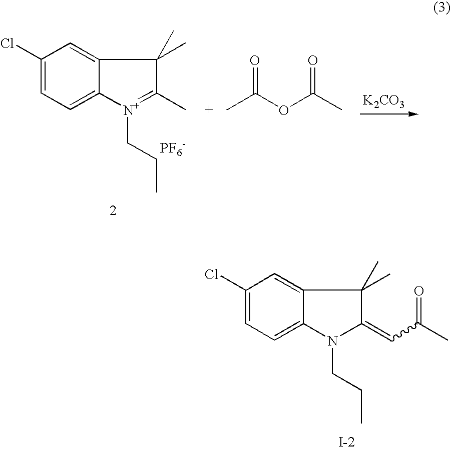

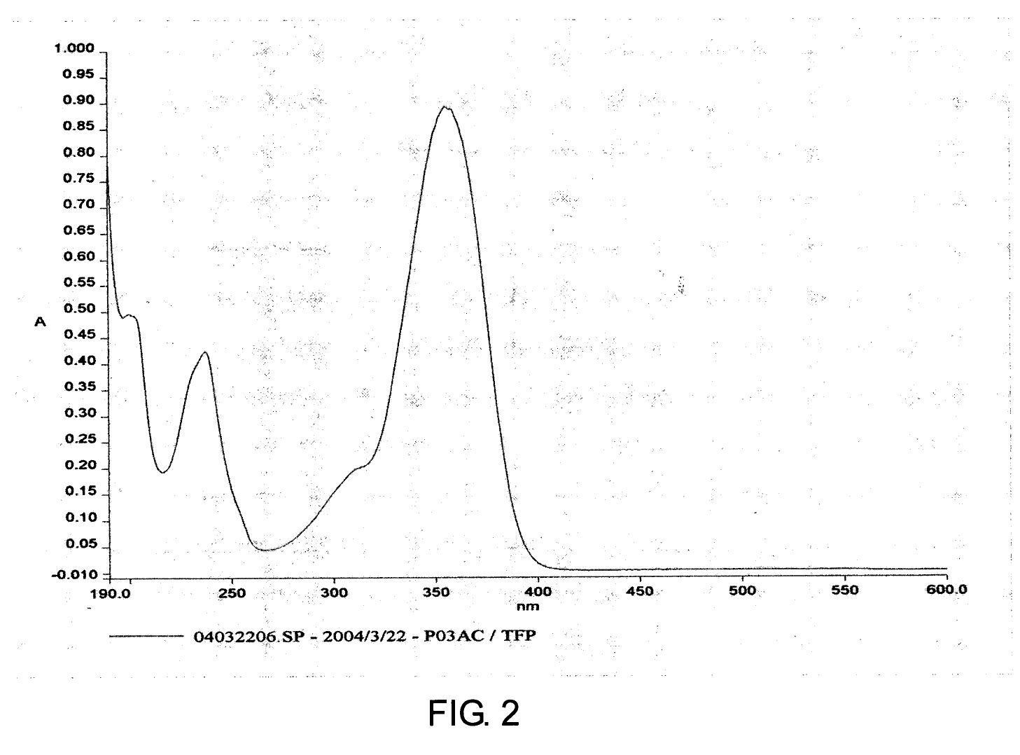

The synthesis process is as shown in the reaction scheme (3). First, 5-Chloro-2,3,3-trimethyl-1 -propylindolinum hexafluorophosphate (formula [2]) (4.9 g, 12.8 mmol), K₂CO₃ (1.5 g, 10.5 mmol), Ac₂O (50 mL) are heated at a temperature of 100° C. for 3 hr. After cooling down to room temperature, the solution is poured into water (100 mL) and then precipitate is appeared. After filtrating and following chromatograph (EA/n-Hexane=85/15), chemical compound of formula [I-2] is obtained in a weight of 2.7 g (57%). The spectrum result, as shown in FIG. 2, UV-VIS (TFP) is; □ₘₐₓ=355 nm (FIG. 2); ¹H NMR (400 MHz, CDCl₃) □ 0.79-0.93 (m, 3H), 1.20-1.33 (m, 2 H), 1.66 (s, 6H), 2.19 (s, 3 H), 3.10-3.20 (m, 2 H), 5.28 (s, 1 H), 6.64 (d, J=8.4 Hz, 1 H), 7.09-7.17 (m, 2 H); ¹³C NMR (100 MHz, CDCl₃) □ 14.5, 23.0, 24.2, 30.0, 30.5, 31.7, 32.2, 48.4, 94.4, 108.5, 122.5, 127.3, 141.7, 170.0, 193.4.

What is claimed is:

1. An optical recording medium provided on a substrate with a recording layer, the recording layer comprising at least one kind of organic compound, wherein the recording layer selectively has a larger sensitivity at the wavelength of laser beam in a range of 300 nm to 550 nm.

2. The optical recording medium according to claim 1, wherein the recording layer comprises a compound represented by the following general formula [I] 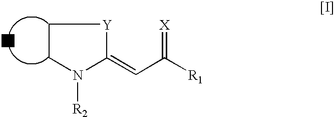
wherein
“R₁” is selected from substituted or unsubstitued alkyl, cyclic alkyl, phenyl, benzyl, alkylphenyl or phenoxyalkyl group;
“R₂” is selected from substituted or unsubstitued alkyl, cyclic alkyl, phenyl, benzyl, alkylphenyl or phenoxyalkyl group;
“A” is selected from phenyl or naphthyl substituted or unsubstitued alkyl, cyclic alkyl, phenyl, benzyl, alkylphenyl or phenoxyalkyl group;
“X” is an electron withdrawing atom or substituted group; and
“Y” is an atom, or a group of CR₃R₄ or NR₅, wherein R₃” and “R₄” are the same or different from each other and selected from ubstituted or unsubstitued alkyl group, cyclic alkyl group or organometallic substitutent; and “R₅” is substituted or unsubstitued alkyl, cyclic alkyl, phenyl, benzyl, alkylphenyl and phenoxyalkyl group.

3. The optical recording medium according to claim 2, wherein a ring structure in formula [I] comprises “R₃” and “R₄”, which are the same or different from each other and individually selected from ubstituted or unsubstitued alkyl group, cyclic alkyl group, or organometallic substitutent.

4. The optical recording medium according to claim 2, wherein “R₅” is substituted or unsubstitued alkyl, cyclic alkyl group, phenyl, benzyl, alkylphenyl or phenoxyalkyl group.

5. The optical recording medium according to claim 2, wherein “X” is an atom of oxygen (O).

6. The optical recording medium according to claim 2, wherein “X” is an atom of sulfur (S).

7. The optical recording medium according to claim 2, wherein “Y” is an atom of oxygen (O).

8. The optical recording medium according to claim 2, wherein “Y” is an atom of sulfur (S).

9. The optical recording medium according to claim 2, wherein “Y” is an atom of selenium (Se).

10. The optical recording medium according to claim 1, wherein the recording layer selectively has a larger sensitivity at the wavelength of laser beam in a range of 350 nm to 450 nm.

11. The optical recording medium according to claim 10, wherein the recording layer selectively has a larger sensitivity at the wavelength of laser beam in a range of 390 nm to 410 nm.
